(19) United States
(12) Patent Application Publication
(10) Pub. No.: US 2002/0038842 A1
(43) Pub. Date: Apr. 4, 2002

(54) Cable holding structure

(75) Inventor: Hideki Adachi, Shizuoka (JP)

Correspondence Address: SUGHRUE, MION, ZINN, MACPEAK & SEAS, PLLC, 2100 Pennsylvania Avenue, N.W., Washington, DC, 20037, US

(73) Assignee: YAZAKI CORPORATION

(21) Appl. No.: 09/968,668

(22) Filed: Oct. 2, 2001

(30) Foreign Application Priority Data
Oct. 2, 2000 (JP) P.2000-302480

(51) Int. Cl. F16L 3/00

(52) U.S. Cl. 248/49

(57) ABSTRACT

A cable holding structure is adapted so that a bent portion (13a) of a flexible flat cable (13) is held by a rotator (11). In this structure, a groove-like holder portion (19), into which the bent portion (13a) is inserted, is formed in the rotator (11). A slit (19a), into which a flexible flat cable (13) extending in one direction X is inserted from the bent portion (13a), and an opening portion (19b), into which another cable (13) extending in another direction Y is inserted from the bent portion (13a), are formed in this holder portion (19). A stopper (19c) abutting against a side edge portion (13b) of the cable (13), which extends in the latter direction Y, is provided on the surface of the slit (19a). A slip-off preventing projection (21) abutting against an upper side edge portion (13c) of the cable (13), which extends in the one direction X, from the bent portion (13a) is provided on the surface of the opening portion (19b).

### BACKGROUND OF THE INVENTION

The present invention relates to a cable holding structure for holding a flexible flat cable (FFC) at predetermined positions thereof. More particularly, the invention relates to a cable holding structure adapted to hold a bent portion of a flexible flat cable connecting a steering wheel side of a steering wheel portion of an automobile to a steering column side thereof.

For example, a related cable holding structure of such a kind is illustrated in FIGS. 5 and 6 and described in JP-A-9-260005. As shown in FIGS. 5 and 6, this cable structure comprises a rotor (or rotator) 1 including an inner cylindrical portion (or internal cylindrical member) 1a, and a stator 2 which includes an outer cylindrical portion (or outside cylindrical member) 2a surrounding the inner cylindrical portion in such a manner as to provide a space having predetermined width therebetween. This cable structure further comprises a flexible flat cable 3 (hereunder referred to simply as a cable 3) accommodated in the annular space K provided between the inner cylindrical portion 1a and the outer cylindrical portion 2a in such a manner as to be wound like a spiral along this space K, and a nearly C-shaped moving element 4 rotationally movably provided along this space K and adapted so as to turn back the cable 3 at an opening portion 4a.

The rotor 1 is provided with a holder portion 1b for fitting and holding a cable holding element 5 provided in an inner peripheral end portion 3a of the cable 3.

On the other hand, a cover member 6 is attached to the stator 2 in such a manner as to cover the topside of the space K and the periphery of the outer cylindrical portion 2a. The cover member 6 comprises an upper cover 6a for covering the topside of the space K, and a cylindrical portion 6b surrounding the periphery of the outer cylindrical portion 2a. The cover member 6 is adapted in such a way as not to perform relative rotation with respect to the stator 2. Further, an opening portion 6c is formed in the central portion of the upper cover 6a. In the stator 2, a lower cover 2b for covering the lower side of the space K is formed in such a manner as to be integral with the outer cylindrical portion 2a. Furthermore, a holder portion 2c for holding the cable holding element 5 provided in the cable 3 is provided in the outer cylindrical portion 2a.

Further, an externally introducing cover 8 for externally introducing the cable 3 is rotatably provided on the topside of the cover member 6. The externally introducing cover 8 is connected to the inner cylindrical portion 1a through the opening portion 6c of the cover member 6, and adapted to rotate together with the inner cylindrical portion 1a. Moreover, a connector holder portion 8a for holding an inner connector 9 of the cable 3 is provided in this externally introducing cover 8.

As shown in FIG. 6, a portion of the cable 3 held by the cable holding element 5 has a bent portion 3b bent at right angle. The cable 3 is formed so that this bent portion 3b forms the boundary between a part extending in a direction X and another part extending in a direction Y, which are orthogonal to each other. Further, the former part of the cable 3 extending in the direction X is placed in the annular space k, and the latter part of the cable 3 extending in the direction Y is led to the externally introducing cover 8. The cable 3 is fixed to a connector holder 8a through the inner connector 9.

Further, as shown in FIG. 6, the cable holding element 5 is formed like a square block. A groove 5a into which the bent portion 3b of the cable 3 is inserted is formed in this block. In the groove 5a, a first opening portion 5b through which the part of the cable 3 extending in the direction X passes, and a second opening portion 5c through which the part of the cable 3 extending in the direction Y passes are formed. Furthermore, a stopper 5d abutting a side edge portion 3c of the cable 3, which extends in the direction Y, for preventing this bent portion 3c from going out therefrom in the direction X is provided in the first opening portion 5b.

However, the related cable holding structure has encountered the problems that a backlash in the upward or downward direction is occurred in a portion of the cable holding element 5, into which the holder portion 1b of the rotor 1 is inserted, that because the cable 3 is rotatably and movably provided along the space K and turned back in an opening portion 4a, the turned-back portion is liable to upwardly and downwardly swing, and the cable 3 is shaken upwardly and downwardly, and that abnormal noises are generated by performing sliding operations between the cabled 3 and each of the cover member 6 and the rotor 1.

Further, in the case of the related cable holding structure, the rotor 1 has a space (that is, the holder portion 1b) for accommodating the cable holding element 5. Thus, it is difficult to take measures to cope with the case that the number of the cables 3 increases.

### SUMMARY OF THE INVENTION

Accordingly, an object of the invention is to provide a cable holding structure, which provides good assemblability and is enabled to reduce the number of components and to cope with an increase in the number of circuits corresponding to flexible flat cables.

To achieve the foregoing object, according to the invention, there is provided a cable holding structure (hereunder referred to as a first structure), in which a bent portion is formed by bending a band-like flexible flat cable at a predetermined portion and is then held by a first one of members each performing relative rotation. The first structure comprises a groove portion formed in the first one of the members and adapted so that the bent portion is inserted into the groove portion, a first slit formed in the groove portion and adapted so that the flexible flat cable extending in a first direction from the bent portion is inserted thereinto, a second slit formed in the second slit formed in the groove portion and adapted so that the flexible flat cable extending in a second direction from the bent portion is inserted thereinto, a first stopper provided in the first slit in such a way as to abut against a side edge portion of the flexible flat cable extending in the second direction from the bent portion, and a second stopper provided in the second slit in such a manner as to abut against a side edge portion of the flexible flat cable extending in the first direction from the bent portion.

In this cable holding structure, the first stopper abuts against the side edge portion of the flexible flat cable extending in the second direction from the bent portion in the first slit during this structure is in a state in which the bent portion of this flexible flat cable is inserted into the groove portion formed in the one of members. Thus, this cable holding structure has an advantageous effect in that the bent portion is prevented from slipping off therefrom in a direction. Moreover, the second stopper formed in the second slit abuts against the side edge portion of the flexible flat cable extending in the first direction from the bent portion. Thus, this structure has an advantageous effect in that the second stopper is prevented from slipping off therefrom in the second direction. Consequently, the flexible flat cable is prevented from being shaken with respect to the one of the members. Furthermore, the flexible flat cable and the one of the members are prevented from performing a sliding operation therebetween to thereby generate abnormal noises. Additionally, the first structure has an advantageous effect in that the number of components is reduced by assembling the bent portion to the one of the members.

According to an embodiment (hereunder referred to as a second structure) of the first structure of the invention, the one of members is a rotator, which is fixed to a steering shaft and has an inner cylindrical portion. Further, the second one of members is a stator, which is fixed to a steering column and has an outer cylindrical portion. Moreover, the flexible flat cable extended from the bent portion in the first direction is disposed between the inner cylindrical portion and the outer cylindrical portion like a spiral.

According to the second structure of the invention, the bent portion of the flexible flat cable is assembled directly to the rotator without using a holding member. Thus, in the rotator, there is room for accommodating the bent portion. Moreover, the second structure has an advantageous effect in that the structure is enabled to cope with an increase in the number of circuits corresponding to the flexible flat cables.

According to an embodiment (hereunder referred to as a third structure) of the second structure of the invention, the groove portion is formed in a wall portion of the inner cylindrical portion formed in the rotator. Further, the first slit is formed in a peripheral wall of the inner cylindrical portion.

According to the third structure of the invention, the groove portion is formed in the wall part of the inner cylindrical portion of the rotator. Thus, a flexible flat cable drawn out of the bent portion in the first direction is easily disposed in the ring-like space provided between the inner cylindrical portion and the outer cylindrical portion of the stator.

### BRIEF DESCRIPTION OF THE DRAWINGS

FIG. 1 is an exploded perspective view illustrating an inter-relative-rotation-member relay that is an embodiment to which the cable holding structure according to the invention is applied.

FIG. 2 is a perspective view illustrating a flexible flat cable and a rotator, which are used in the cable holding structure embodying the invention.

FIG. 3 is a plan view illustrating the rotator of the embodiment of the invention.

FIG. 4 is a sectional view taken on line A-A of FIG. 3.

FIG. 5 is an exploded perspective view illustrating an inter-relative-rotation-member relay to which a related cable holding structure is applied.

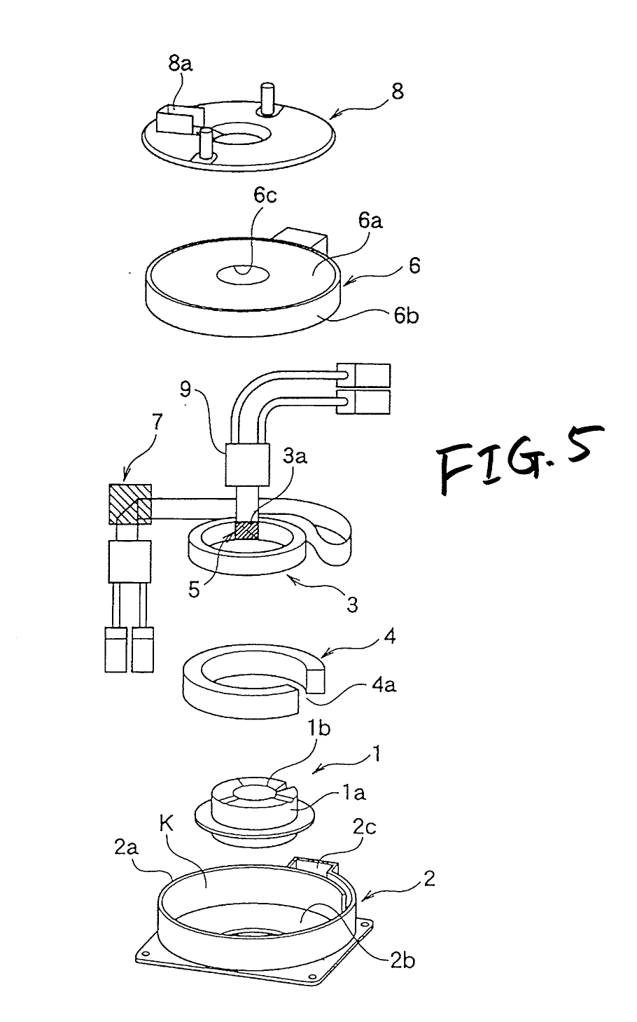

FIG. 6 is an exploded perspective view illustrating the related cable holding structure.

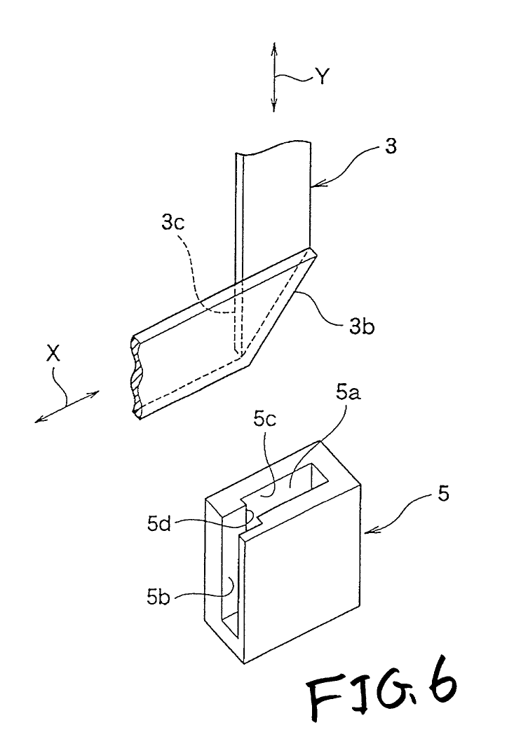

### DETAILED DESCRIPTION OF PREFERRED EMBODIMENT

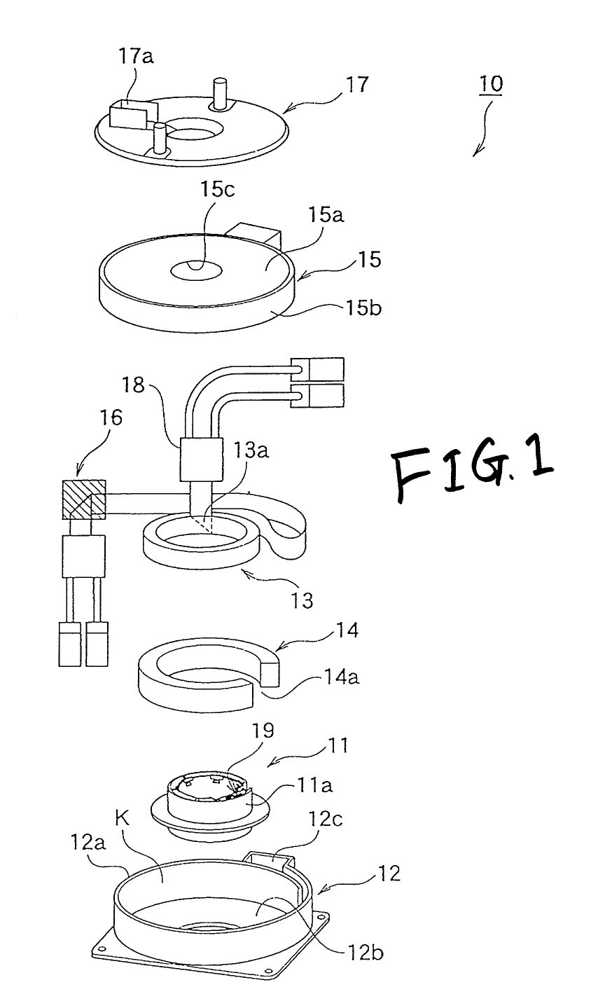

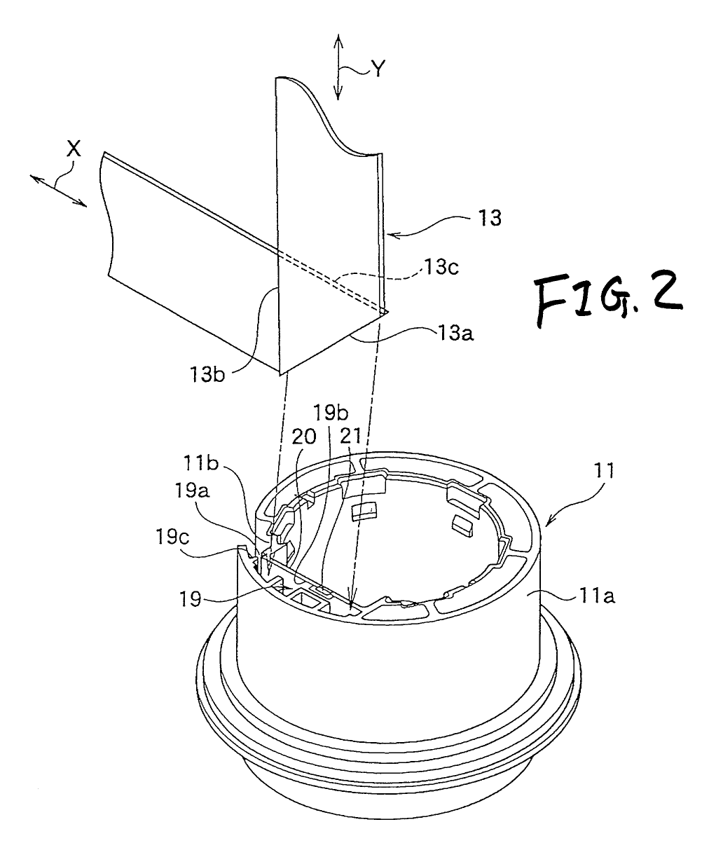

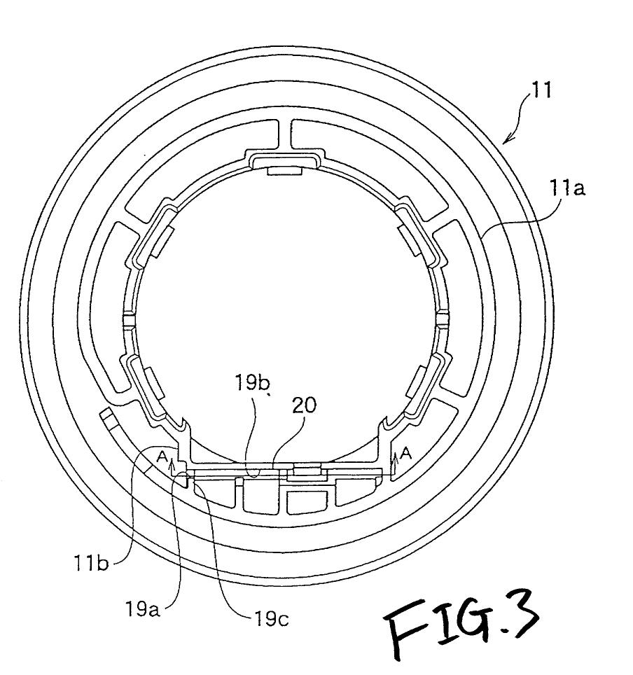

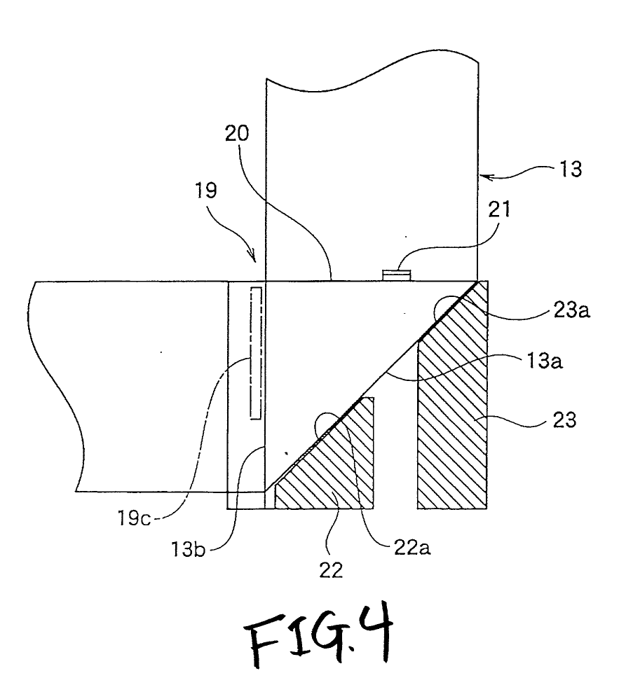

Hereinafter, a cable holding structure according to an embodiment of the invention is described in detail with reference to the accompanying drawings. This embodiment is obtained by applying the invention to an inter-relative-motion-member relay apparatus (hereunder referred to simply as a relay apparatus) using a flexible flat cable (FFC), which electrically connects a steering wheel side of a steering wheel portion of an automobile to a steering column side thereof. FIG. 1 is an exploded perspective view illustrating the relay apparatus according to the invention. FIG. 2 is an exploded perspective view illustrating a cable holding structure to be applied to the relay apparatus. FIG. 3 is a plan view illustrating a rotator (or rotor) serving as a cable holding portion. FIG. 4 is a sectional view taken on line A-A of FIG. 3, which shows a cable holding state.

As illustrated in FIG. 1, this relay apparatus 10 comprises a synthetic resin rotator 11 including an inner cylindrical portion (an internal cylindrical member) 11a, and a stator 12 including an outer cylindrical portion (or outside cylindrical member) 12a surrounding the inner cylindrical portion in such a manner as to provide a space of predetermined width therebetween. This relay apparatus 10 further comprises a flexible flat cable 13 (hereunder referred to simply as a cable 13) accommodated in the ring-like space K provided between the inner cylindrical portion 11a and the outer cylindrical portion 12a in such a manner as to be wound like a spiral along this space K, and a nearly C-shaped synthetic resin moving element 14 rotationally movably provided along this space K and adapted in such a way as to turn back the cable 13 in an opening portion 14a.

On the other hand, a synthetic resin cover member 15 is provided on the stator 12 in such a manner as to cover the topside of the space K and the periphery of the outer cylindrical portion 12a. This cover member 15 comprises an upper cover 15a for covering the topside of the space K, and a cylindrical portion 15b surrounding the periphery of the outer cylindrical portion 12a. The cover member 15 is adapted in such a way as not to perform relative rotation with respect to the stator 12. Further, an opening portion 15c is formed in the central portion of the upper cover 15a. Moreover, in the stator 12, a lower cover 12b for covering the lower side of the space K is formed in such a manner as to be integral with the outer cylindrical portion 12a. Furthermore, a holder portion 12c for holding the cable holding element 16 provided in the cable 13 is provided in the outer cylindrical portion 12a.

An externally introducing synthetic resin cover 17 for externally introducing the cable 13 is rotatably provided on the topside of the cover member 15. This externally introducing cover 17 is connected to the inner cylindrical portion 11a through the opening portion 15c of the cover member 15, and adapted to rotate together with the inner cylindrical portion 11a. Moreover, a connector holder portion 17a for holding an inner connector 18 of the cable 13 is provided in this externally introducing cover 17.

As shown in FIG. 2, the cable 13 is formed so that a bent portion 13a forms the boundary between a part extending in a direction X and another part extending in one direction Y, which are orthogonal to each other. Further, the former part of the cable 13, which extends in the direction X, is placed in the ring-like space k, while the latter part of the cable 13, which extends in the direction Y, is led to the externally introducing cover 17. The cable 13 is fixed to a connector holder 17a through the inner connector 18.

As shown in FIG. 2, a grove-like holder portion (or groove portion) 19 into which the bent portion 13a of the cable 13 is inserted is formed in the inner cylindrical portion 11a of the rotator 11. Further, this holder portion 19 is formed by being surrounded by the wall of the inner cylindrical portion 11a and a plate-like inner wall 20 formed on the inner side of the inner cylindrical portion 11a. In this holder portion 19, a slit (that is, a first slit) 19a, into which the cable 3 extending in the one direction X is inserted in the direction of width thereof, is formed. An inwardly concave groove 11b is formed along the direction Y on the one side in the direction of circumference of the holder portion 19 in the inner cylindrical portion 11a of the rotator 11. Moreover, the slit 19a is formed in the groove wall of this concave groove 11b. Furthermore, the holder portion 19 includes an opening portion (that is, a second slit) 19b, through which the cable 13 extending in another direction Y passes.

Further, the slit 19a is set in a gap of a width that is equal to the thickness of the cable 13. As illustrated in FIGS. 2 to 4, a stopper (that is, a first stopper) 19c is formed on an outer opening edge of the slit 19a and is adapted to abut against the side edge portion 13b of the cable 13 extending in the other direction Y for preventing this bent portion 13a from going off in the one direction X. A slip-off preventing projection (that is, a second stopper) 21 is provided on the upper opening edge (that is, a part thereof facing the opening portion 19b) in such a way as to protrude therefrom. As illustrated in FIG. 4, the slip-off preventing projection 21 has the functions of abutting against an upper edge portion (that is, a side edge portion) 13c of the cable 13 extending in the one direction X from the bent portion 13a, and preventing this bent portion 13a from going off in the other direction Y. Bottom plate portions 22 and 23 respectively having slopes 22a and 23a provided along the bottom edge of the inserted bent portion 13a are integrally formed on the bottom portion of the holder portion 19 in such a way as to project therefrom.

Thus, the insertion of the bent portion 13a of the cable 13 into the holder portion 19 formed in the inner cylindrical portion 11a of the rotator 11 causes the stopper 19c to abut against the side edge portion 13b of the cable 13 extending in the latter direction Y from the bent portion 13a. Moreover, the slip-off projection 21 is placed in such a manner as to abut against the side edge portion 13c of the cable 13 extending in the direction of the one direction X from the bent portion 13a. Consequently, the cable 13 is not shaken upwardly and downwardly with respect to the rotator 11. Moreover, the sliding operations are restrained from being performed between the cable 13 and each of the rotator 11 and the cover member 15. Consequently, abnormal noises are prevented from being generated as the steering wheel is turned.

Furthermore, the aforementioned embodiment is constructed so that the cable 13 is inserted directly into the holder portion 19 of the rotator 11 without using the cable holding element. Thus, there is sufficient space for accommodating the cable. Consequently, the embodiment easily copes with the case that the number of circuits corresponding to the cables 13 increases. Furthermore, the cable 13 can be held without using the cable holding element. Thus, the assemblability is enhanced. Moreover, the number of components is reduced.

Although the embodiment is described in the foregoing description, the invention is not limited thereto. Various changes may be made according to the gist of the invention. For example, in the aforementioned embodiment, the relay apparatus 10 has the moving element 14. However, needless to say, the invention can be applied to an apparatus that does not have the moving element 14.

As described above, according to the invention, the first stopper abuts against the side edge portion of the cable to thereby prevent the bent portion from slipping off in a direction. Moreover, the second stopper abuts against the side edge portion of the flexible flat cable extending a direction from the bent portion. Thus, the bent portion is prevented from going off therefrom in the one direction or in the other direction. Consequently, the cable is reliably held. Therefore, the flexible flat cable is prevented from being shaken with respect to one of the relative rotation members. Furthermore, the flexible flat cable and the one of the members are prevented from performing a sliding operation therebetween to thereby generate abnormal noises. Additionally, the first structure has an advantageous effect in that the number of components is reduced by assembling the bent portion and the one of the members.

According to the invention, the bent portion of the flexible flat cable is assembled directly to the rotator without using a holding member. Thus, in the rotator, there is room for accommodating the bent portion. Moreover, the second structure has an advantageous effect in that the structure is enabled to cope with an increase in the number of circuits corresponding to the flexible flat cables. This enables an increase in the number of signal input/output paths and electric power supply paths provided between the steering wheel side and the steering column.

According to the invention, the groove portion is formed in the wall part of the inner cylindrical portion of the rotator. Thus, a flexible flat cable drawn out of the bent portion in one direction is easily disposed in the ring-like space provided between the inner cylindrical portion and the outer cylindrical portion of the stator. Consequently, the flexible flat cable is placed without laboring.

What is claimed is:

1. A cable holding structure, in which a bent portion is formed by bending a band-like flexible flat cable at a predetermined portion and held by a first one of members each performing relative rotation, the cable holding structure comprising:
a groove portion formed in the first one of members and adapted so that the bent portion is inserted into the groove portion;
a first slit formed in the groove portion and adapted so that the flexible flat cable extending in a first direction from the bent portion is inserted thereinto;
a second slit formed in the groove portion and adapted so that the flexible flat cable extending in a second direction substantially perpendicular to the first direction from the bent portion is inserted thereinto;
a first stopper provided in the first slit for abutting against a side edge portion of the flexible flat cable extending in the second direction from the bent portion; and
a second stopper provided in the second slit for abutting against a side edge portion of the flexible flat cable extending in the first direction from the bent portion.

2. The cable holding structure according to claim 1, wherein
the first one of members is a rotator fixed to a steering shaft and including an inner cylindrical portion,
a second one of members is a stator fixed to a steering column and including an outer cylindrical portion, and
the flexible flat cable extended from the bent portion in the first direction is disposed between the inner cylindrical portion and the outer cylindrical portion like a spiral.

3. The cable holding structure according to claim 2, wherein the groove portion is formed in a wall portion of the inner cylindrical portion formed in said rotator, and wherein said first slit is formed in a peripheral wall of said inner cylindrical portion.
